(19) United States
(12) Patent Application Publication
(10) Pub. No.: US 2010/0082693 A1
(43) Pub. Date: Apr. 1, 2010

(54) ORGANIZATION OF A CONTACT LIST BASED ON SOCIAL NETWORK CONTEXT

(76) Inventors: Ethan Hugg, Seattle, WA (US); Matthew Kuhlke, San Francisco, CA (US); Chin-Ju Chen, Cerritos, CA (US); Eric Heng Chih Lee, Cerritos, CA (US)

Correspondence Address: BRINKS HOFER GILSON & LIONE, P.O. BOX 10395, CHICAGO, IL, 60610, US

(21) Appl. No.: 12/238,068

(22) Filed: Sep. 25, 2008

(51) Int. Cl. G06F 17/30

(52) U.S. Cl. 707/798; 707/E17.009

(57) ABSTRACT

The method includes determining a social network weighting for one or more contacts in a contact list, and arranging the contact list as a function of the social network weighting for the one or more contacts. The social network weightings may be determined as a function of social network context, which may include social network interactions, social network associations, or social network activities.

### BACKGROUND

1. Field of Technology

The present embodiments relate to organizing a contact list based on social network context.

2. Background of Technology

A cell phone user may use a contact list to look up contact information. To locate contact information, the cell phone search may be based on various inputs from the user. Once located, the contact information may be selected to initiate connection with the other communication device.

### BRIEF DESCRIPTION OF THE DRAWINGS

FIG. 1 illustrates one embodiment of a system for arranging a contact list;

FIG. 2A illustrates one embodiment of a communication device, and

FIG. 2B illustrates one embodiment of a server 40;

FIG. 3 illustrates one embodiment of a contact list;

FIG. 4 illustrates an example of social network context;

FIG. 5 illustrates one embodiment of a weighting table;

FIG. 6 illustrates an example of social network weightings;

FIGS. 7A, 7B, and 7C illustrate additional embodiments of contact lists; and

FIG. 8 illustrates one embodiment of a method for arranging a contact list.

### DETAILED DESCRIPTION

The present embodiments relate to arranging or organizing a contact list based on social network service context. A “contact” may be a person or device that uses a communication device to communicate. A “contact list” may be a listing of one or more contacts. The contact list may include contact information used to communicate with one or more of the contact's communication devices. For example, the contact list may include a contact's email address and phone number. The contact information may be selected to initiate communication with the contact.

The contact list may be arranged based on social network service context. A social network service uses software to build online social networks. The social network service context may be used to determine the likelihood that a contact or contact information will be selected from the contact list. For example, increased interaction with a contact using a social network service may increase the likelihood that a contact will be selected.

In a first aspect, an apparatus includes a memory; and a processor in communication with the memory. The memory includes computer code executable with the processor. The computer code is configured to determine one or more social network weightings for one or more contacts in a social network. The social network weightings are determined based on social network context. The one or more social network weightings are operable to be used to arrange a contact list as a function of the social network weightings for the one or more contacts in the social network.

In a second aspect, a method includes determining a social network weighting for one or more contacts in a contact list, and arranging the contact list as a function of the social network weighting for one or more contacts.

In a third aspect, a system includes a memory having generating instructions that are executable to generate a social network weighting for a contact in a contact list and a social network; and a processor that is operable to execute instructions stored in the memory.

As one example, Bob Johnson uses Facebook to build an online social network, which includes Mary Johnson, Jack Wo, Jane Doe (4), Jane Doe (5), and David Smith. Bob uses Facebook to interact with the individuals in the online social network. For example, Bob can send/receive messages, join groups, and update his profile. Bob's interaction with the individuals is used to generate a social network weighting for each individual in the online social network. The type and amount of interaction with a contact determines the weight of a social network weighting for that contact. For example, increased interaction may increase the weight of the social network weighting. The social network weighting may be used to arrange Bob's cellular phone contact list. For example, Bob may be trying to call Jack Wo. Bob uses his cellular phone to search for Jack Wo's phone number in the cellular phone contact list. Jack's social network weighting is used to determine Jack's place in the cellular phone contact list. For example, if Jack Wo's social network weighting has the greatest weight relative to the other individuals, Jack Wo's contact information may be disposed at the top of the cellular phone contact list.

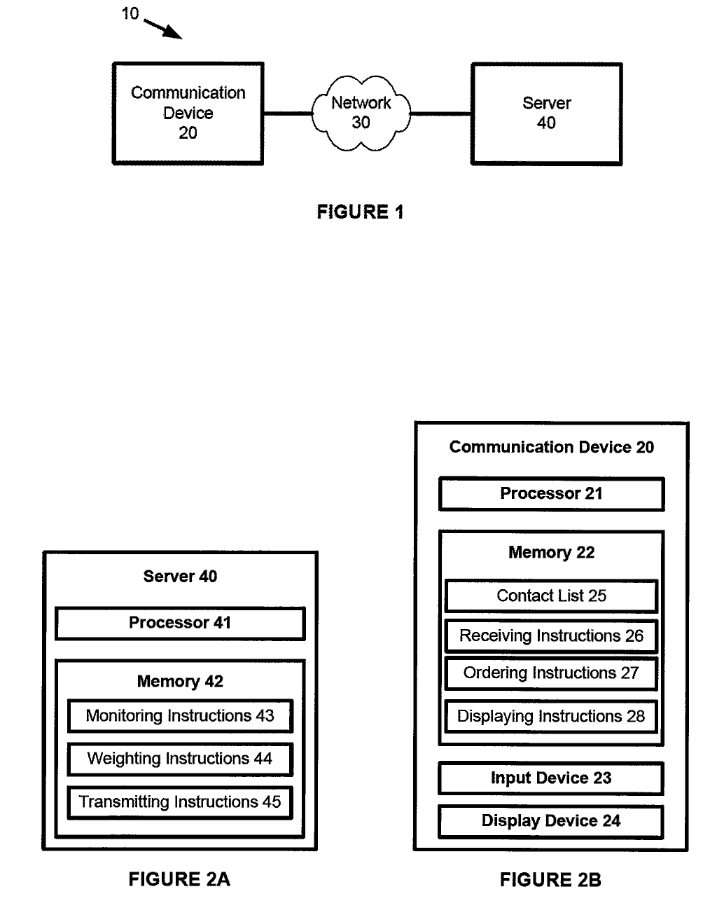

FIG. 1 shows a system 10 for arranging a contact list 25. The system 10 may include a communication device 20, a network 30, and a server 40. Additional, different, or fewer components may be provided. For example, the system 10 may include a plurality of communication devices 20 or servers 40. As another example, the communication device 20 may perform the functions of the server 40.

The system 10 is a network of communication devices, routers, servers, workstations, personal computers, any combination thereof, or other now known or later developed system for providing predictive support. For example, the system 10 is a network of devices that automatically arranges a contact list 25 based on social network service context. Automated assistance is provided to a user for predicting a desired contact in a contact list 25. In another example, the system 10 is a server that automatically weights social network service context. The weights may be determined based, directly or indirectly, on the likelihood that a contact will be selected from the contact list 25. The weights may be used to determine a social network weighting for each individual in the social network. In another example, the system 10 is a communication device for intelligent dialing. Intelligent dialing may combine keystrokes and weighted interactions to predict the contact that is likely to be selected.

The network 30 interconnects the communication device 20 and server 40. The network 30 may be used for communication. The communication may include transmission using any now known or later developed protocol. For example, the Internet Protocol (IP) or the Transmission Control Protocol (TCP) may be used.

FIG. 2A shows one example of a server 40. The server 40 may include a processor 40 and memory 41. Additional, different, or fewer components may be provided.

The server 40 may be a web server, remote terminal server, network server, central server, personal server, or any other now known or later developed server. The server 40 may support client interaction with web applications. For example, the server 40 may operate to accept an HTTP request from a client, and provide an HTTP response to the client. The HTTP response may be an HTML document, but can also be a raw file, an image, or some other type of document.

The processor 41 may monitor a social network service. Monitoring may include logging, recording, copying, observing, tracking, documenting, requesting, or reporting. The social network service may be an online social network service, a communication service, a networking service, or any other service for social networking. For example, a social network service may be an online social networking service for building a network 51 and interacting with people, groups, or organizations. In another example, a social network service may be a communication service for communication service with one or more individuals in a network 51. In another example, a social network services 50 is, for example, a social service (e.g., MySpace), a business network service (e.g., Linked-In), a dating service network (e.g., Harmony.com), or an invitation service (e.g., Evite). In the example above, Facebook is the social network service. The server 40 may monitor Bob's use of Facebook. The server 40 may monitor use of multiple social networks.

A social network service may be used to establish a social network 51. The network 51 may be a community of people who share interests and activities or who are interested in exploring the interests and activities of others, such as an association of individuals. For example, social network service users may be an online association of friends, colleagues, acquaintances, or business partners. The network 51 may be customized or defined by a social network service user. The user may accept or reject requests to be in the user's network 51. In the example above, Bob Johnson is the social network service user. Bob Johnson uses Facebook to build a social network 51, which Facebook labels “Friends.” Accordingly, Bob may use Facebook to invite someone to be his Friend or in the social network 51. Bob may also reject or accept another individual's invitation to be a Friend.

The processor 40 may generate one or more social network weightings for individuals in the social network 51. A social network weighting may be a rating, ranking, vote, score, word, bit, byte, or other factor for determining the likelihood that the social network service user will contact the individual in the social network 51. For example, the weighting may be a numerical score, such as +10 or +5. In another example, the weighting may a word, such as “important” or “average.”

The social network weighting is determined as a function of social network service context. Social network service context may include social network interaction, social network association, online social network activities, number of shared links (e.g., number of shared friends) or any combination thereof. Additional, different, or less social network service features may be included as social network context. FIG. 4 illustrates examples of online social network interaction and social network association.

A social network interaction may include communication, chat, messaging, email, video sharing, voice chat, text chat, game playing, file sharing, wall posting, blogging, discussion groups, calls, or any combination thereof. As shown in FIG. 4, a public message 52 and a private message 53 are social network interactions. Using Facebook as a social network service, the public message 52 is a wall post and the private message 53 is a personal message.

A social network association may include inclusion in a social network 51. The social network 51 may be individuals having mutual association, one-way association, direct association, indirect association, short term association, long term association, or any combination thereof. In the example above, as shown in FIG. 4, the inclusion of Mary Johnson in Bob Johnson's network 51 may be a social network association.

A social network association may also include association with an individual in a social network group. The social network group may be a group of individuals having a similar interest, such as collecting antiques. The group may include individuals that are not in network 51. In the example above, Bob Johnson may join a group, such as “10,000 people against World Hunger.” The individuals associating with “10,000 people against World Hunger” may or may not be in Bob's social network 51.

A social network association may also include association with an individual associated with a social network event 54. A social network event 54 may be a group of individuals that plan to be at a certain place during a particular interval of time. Individuals that plan to attend the event may join the social network event 54. In the example above, as shown in FIG. 4, Bob Johnson, Jack Wo, and Mary Johnson are planning to attend a party. The party is an event 54. The event 54 may associate Bob, Jack, and Mary. Examples of social network events may include a meeting, gathering, a traveling, and a game.

A social network activity may include updating, adding, deleting, or changing a social network profile 55. In the example above, as shown in FIG. 4, features in profile 55 may be added, deleted, or changed. For example, Bob Johnson may update his phone number, email address, status, availability, photos, or other social network features.

The processor 41 may associate, assign, or relate a social network context weight to a social network context. For example, one, some, or all of the social network interactions, associations, or activities may receive a social network context weight. The weights may be fixed or adjusted. The social network context weights may be defined based on the likelihood that an individual will be contacted.

The social network context weight may indicate the importance of the interaction, association, or activity with respect to determining the likelihood that an individual will be contacted by the social network service user. For example, a greater social network context weight may indicate an increased likelihood that an individual in the social network 51 will be contacted. In an alternative example, a lower social network context weight may indicate an increased likelihood that an individual in the social network 51 will be contacted.

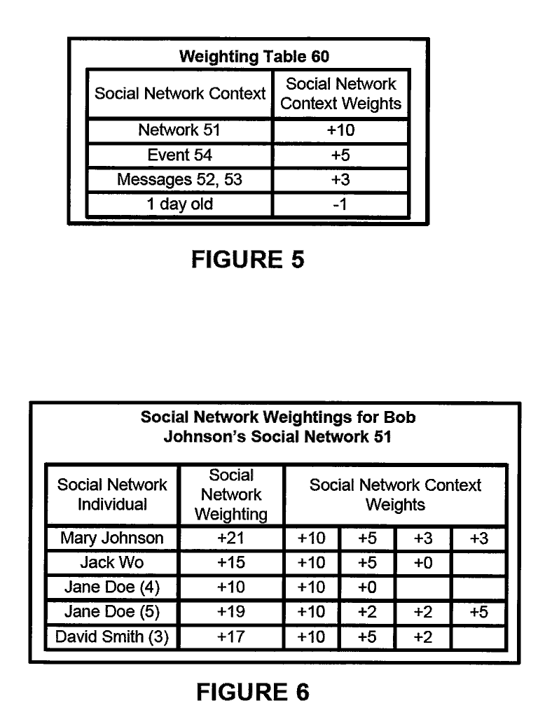

As shown in FIG. 5, the processor 41 may use a weighting table 60 to associate, assign, or relate a social network context weight to social network context. In the example of FIG. 5, a social context weight of +10 may be associated with an individual in the network 51. The social network service user may be more likely to contact an individual in the social network 51 than an individual not in the social network 51. For example, Bob Johnson may be more likely to contact Jane Doe (4) (in social network 51) than Jane Doe (3) (not in social network 51). A social interaction weight of +5 may be associated with an individual that is associated with the same group or event 54. A social interaction weight of +3 may be associated with an individual that sends or receives a message 52, 53 from the social network service user.

In one example, a social network weight may be increased for based on the number of mutual contacts or the degrees of mutual contacts in a social network 51. The number of mutual contacts is the number of contacts in network that are also in another network. For example, if Mary Johnson has a network that includes David Smith (1), David Smith (2), and David Smith (3), then Mary and Bob have one (1) mutual contact—David Smith (3). Another contact, such as Jack Wo, may have two (2) mutual contacts with Bob Johnson. Accordingly, Jack Wo's social network weight may be increased more than Mary Johnson's social network weight.

A social network weight may be reduced for social network context that is less-relevant. Social network context that is less-relevant may include social network context that is not current. For example, an individual that has recently communicated with the social network service user may have a greater likelihood of being contacted, than an individual that has not communicated with the user recently. As shown in FIG. 5, a social context weight of −1 may be associated with each day that passes since the social network context occurred, until the social interaction weight is reduced to 0. In the example above, since Jane Doe (5) sent Bob Johnson a private message 53 yesterday, the weight of the private message 53, which was originally assigned a weight of +3, is summed with −1, since the private message was sent one day ago.

A social network weight may be reduced based on decay over time, a list of mutual contacts is reduced, you are removed from a network, the amount of time that it takes for communication to be deleted, when one individual does not return communication from another individual. For example, if Jack Wo is removed from network 51, then Jack Wo may have a social interaction weight that is reduced to 0 or a negative value. In another example, if Mary Johnson continuously sends Bob Johnson private messages 53, but Bob Johnson does not return the messages 53, then Mary Johnson may have a social interaction weight that is reduced to 0 or a negative value.

The processor 41 may sum the social network weights of an individual in the social network 51. The sum of the social network weights is the social network weighting for the individual in the social network 51.

FIG. 6 is an example of social network weightings for individuals in the social network 51. The social network weightings may be determined by summing the social network context weights associated with an individual in the network 51. For example, Mary Johnson has a social network weighting of +21. Mary Johnson's social network weighting is determined by summing +10 (e.g., since Mary is in the network 51), +5 (e.g., since Mary joined the party event 54), +3 (e.g., since Mary sent a public message 52 today), and +3 (e.g., since Mary sent a private message 53 today). In another example, Jack Wo has a social network weighting of +15. Jack Wo's social network weighting is determined by summing +10 (e.g., since Jack is in the network 51), +5 (e.g., since Jack joined the party event 54), and +0 (e.g., since Jack sent a private message 53 more than three days ago, which reduced the +3 to +0).

The processor 40 may transmit one or more social network weightings to the communication device 40. Alternatively, the processor 40 may transmit social network context information to the communication device 40. The processor 21 may use the social network context information to generate social network weightings. In other alternatives, the processor 40 transmits a relative ranking of the contacts. As used herein, logic encoded in one or more tangible media for execution is defined as the instructions that are executable by the processor and that are provided on the computer-readable storage media, memories, or a combination thereof.

The memory 42 is computer readable storage media. The memory 42 may store data representing instructions executable by a programmed processor, such as the processor 41 for determining a social network weighting. The instructions may include acts shown in the Figures or described herein. For example, as shown in FIG. 2A, the memory 42 may include monitoring instructions 43, weighting instructions 44, and transmitting instructions 45. Additional, different, or fewer instructions may be provided. For example, aggregating instructions may be stored. The aggregating instructions may be executed to aggregate social network context from one or more social network services.

The monitoring instructions 43 may be executed to monitor a social network service. The social network service is monitored to identify social network context. For example, the monitoring instructions 43 are executable to identify social network interactions, such as messages, and social network associations.

The weighting instructions 44 may be executed to generate a social network weighting for individuals in the network 51. The weighting instructions 44 may relate social network context to a social network context weight. The social network context weight may indicate the relevance of the social network context, with respect to determining the likelihood a user will contact an individual in the social network. The weighting instructions 44 may be executed to sum the social network context weights for an individual. Summing the social network context weights may include increasing or decreasing the weight of the social network weighting based on the social network context weight.

The transmitting instructions 45 may be executed to transmit one or more social network weightings or social network context information to a communication device.

FIG. 2B shows a communication device 20. The communication device 20 includes a processor 21, memory 22, input device 23, and display device 24. Additional, different, or fewer components may be provided. For example, the communication device 20 may include a transmit/receive device for transmitting and/or receiving communication.

The communication device 20 is a telephone, cellular phone, mobile phone, telecommunications device, satellite phone, wireless phone, Internet Protocol (IP) phone, voice-over-IP (VOIP) device, personal digital assistant (PDA), network phone, personal computer, server, remote terminal, network endpoint, session initiation protocol (SIP) device, or any other now known or later developed device for communicating with other communication devices. For example, the communication device 20 is a cellular phone for communicating over a cellular network of base stations. In another example, the communication device 20 is a personal computer for communicating over the Internet. In the example above, Bob Johnson's cellular telephone is the communication device 20.

The processors 21, 41 are general processors, digital signal processors, application specific integrated circuits, field programmable gate arrays, analog circuits, digital circuits, combinations thereof, or other now known or later developed processors. The processors 21, 41 may be single devices or a combination of devices, such as associated with a network or distributed processing. Any of various processing strategies may be used, such as multi-processing, multi-tasking, parallel processing, or the like. Processing may be local, as opposed to remotely. For example, the processor 21 is operable to perform processing completed by the processor 41. The processors 21, 41 are responsive to instructions stored as part of software, hardware, integrated circuits, firmware, micro-code or the like.

The processor 21 may receive one or more social network weightings for one or more individuals in the social network 51. For example, the social network weightings may be received from the server 40.

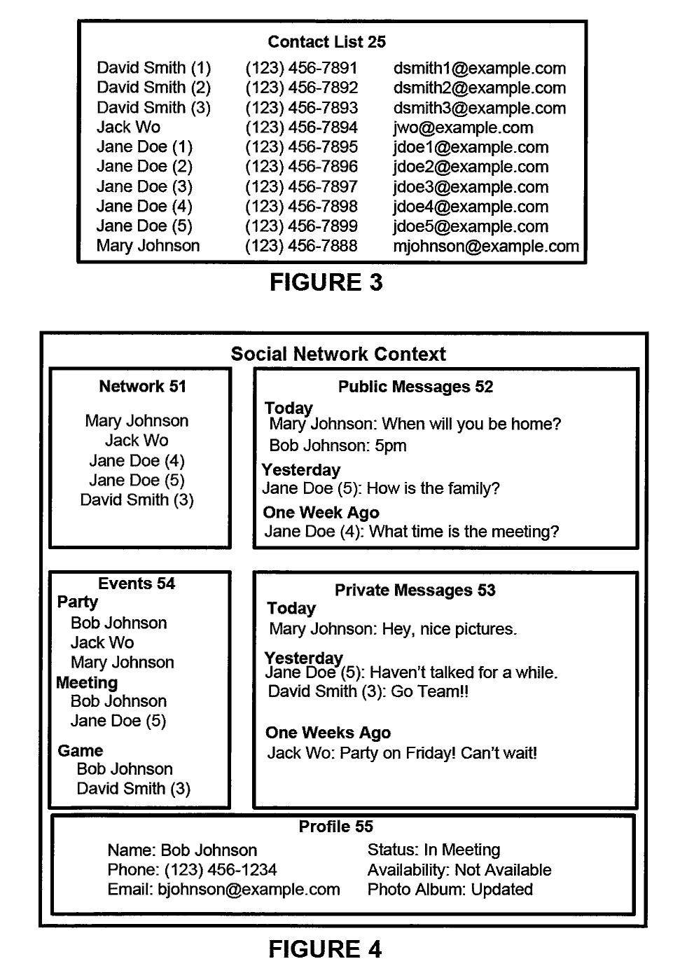

The processor 21 may access a contact list 25. Accessing the contact list 25 may include retrieving from memory 22, requesting and/or receiving from another communication device or server 40, or using any other now known or later developed technique for accessing a contact list 25. Universal, global, local, shared, private, public, or network contact listing techniques may be used. For example, the processor 21 may retrieve a local contact list 25 stored in memory 22. In the example above, as shown in FIG. 3, Bob Johnson's contact list 25 is a global contact list, which includes contacts associated with Bob. Contacts associated with Bob may include contacts stored in his cellular telephone, his personal computer, his employer's network contact list, his online social network 51, his wife's communication device, and/or combinations thereof. Bob may use his cellular telephone to access the contact list 25.

The contact list 25 may include contact information for one or more contacts. The contact information may include identification information, address information, a combination thereof, or other information relating to the contact. Additional, different, or less information may be provided in the contact list 23. For example, the contact list 25 may include notes, photos, or remarks related to the contact. In the example above, as shown in FIG. 3, the contact's name (e.g., Jack Wo) is the identification information, and the contact's phone number (e.g., (123) 456-7894) and email address jwo@example.com are the address information.

The contact information may be used to connect with the contact. Connecting with the contact may include establishing a connection with a communication device, sending a message to an address, or any other communication process. For example, the contact information may include a phone number. Once the contact is selected, the communication device 20 may dial the phone number. In another example, the contact information may be a VOIP address. Once selected, the communication device 20 may establish a VOIP connection to the VOIP address for VOIP communication.

The processor 21 may automatically arrange the contact list 21. Arranging may include ordering, sequencing, organizing, sorting, systemizing, negotiating, comparing, correlating, coordinating, or any process of placing in an order. The processor 21 may arrange all, some, or none of the contact list 21 in one or more sequences. For example, the contact list 21 may be arranged alphabetically, numerically, based on one or more social network weightings, based on one or more inputs, any combination thereof, or based on any other ordering technique.

The processor 21 may update the contact list 25 based on social network context information. For example, if Jack Wo changes a phone number in his profile of the social network service, the phone number may be updated in the contact list 25. In another example, if Bob Johnson adds more individuals to the social network 51, the individual's contact information may be added into the contact list 25. For example, if Sue Tomlison is added to the social network 51, then Sue Tomlison's name and phone number may be added to the contact list 25.

The processor 21 may arrange the contact list 25 as a function of social network service context. Arranging the contact list 25 may include comparing social network service weightings and placing the contacts in order based on the social network service weightings, other social network context information, input information, a combination thereof, or other information used to identify a likely contactee.

The processor 21 may compare social network weightings. Comparing may include determining the contacts with the greatest social network weighting or the least social network weighting. The social network weightings for one, some, or all of the contacts in the contact list 25 may be compared to the social network weightings for one, some, or all of the contacts in the contact list 25. For example, the social network weighting for Mary Johnson (+21) may be compared to the social network weighting for David Smith (3). In another example, the social network weighting for Mary Johnson (+21) may be compared to the social network weighting for Jane Doe (3) (N/A).

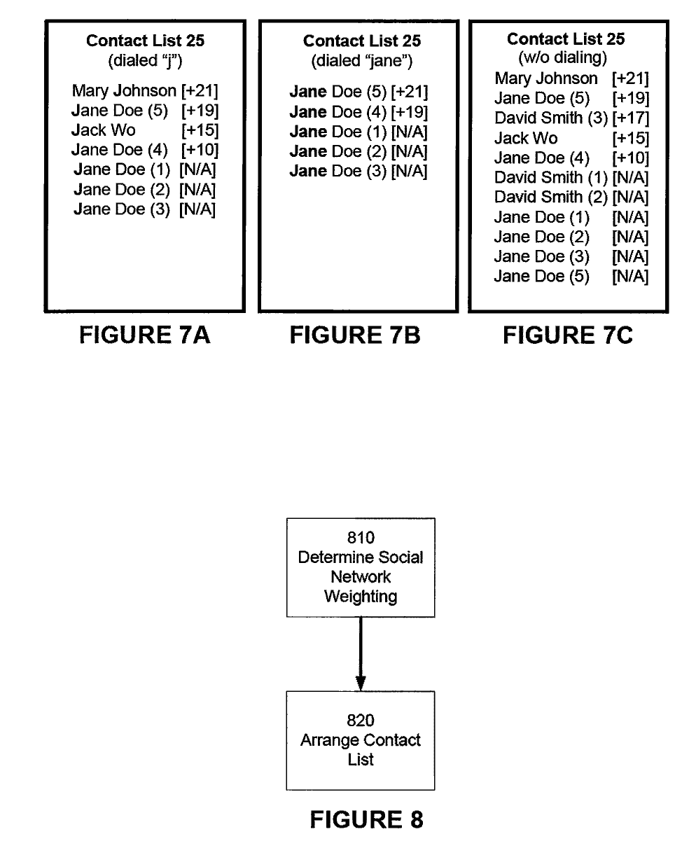

The processor 21 may place the contacts in order based on the social network service weightings, other social network context information, input information, a combination thereof, or other information used to identify a likely contactee. For example, as shown in FIGS. 7A and 7B, the contact list 25 is arranged as a function of the social network weightings and input from an input device 23. In another example, as shown in FIG. 7C, the contact list 25 is arranged as a function of the overall weighting.

FIG. 7A shows a contact list 25 that is arranged as a function of the social network weightings and input from an input device 23. The input device 23 is used to input “j.” The “j” is used to identify contacts in the contact list 25 with a “j” in the contact's first or last name. The contacts with a “j” in the contact's first or last name and with the greatest social network weighting (e.g., with the highest social network weighting in FIG. 6) are displayed at the top of a contact list 25. For example, since Mary Johnson's last name begins with a “j” and Mary's social network weighting is greater than the other contacts with a “j” in the contact's first or last name, Mary Johnson's name is arranged at the top of the contact list 25. The contacts that do not have a social network weighting (e.g., are in the contact list 25, but not in the social network 51) are arranged in any order, such as alphabetical or numerical order.

FIG. 7B shows a contact list 25 that is arranged as a function of the social network weighting and input from an input device 23. The input device 23 is used to input “jane.” The “jane” is used to identify contacts in the contact list 25 with “jane” in the contact's first or last name. The contacts with a “j” at the beginning of the first or last name and with the greatest social network weighting (e.g., with the highest social network weighting in FIG. 6) are displayed at the top of a contact list 25. For example, since Jane Doe (5)'s first name is “jane” and her social network weighting is greater than the other contacts with “jane” in the contact's first or last name, Jane Doe (5)'s name is arranged at the top of the contact list 25. The contacts that do not have a social network weighting are arranged in any order, such as alphabetical or numerical order.

FIG. 7C shows a contact list 25 that is arranged as a function of the social network weighting. The contacts with the greatest social network weighting (e.g., with the highest social network weighting in FIG. 6) are displayed at the top of a contact list 25. For example, since Mary Johnson's overall weighting is greater than the other contacts in the contact list 25, Mary Johnson's name is arranged at the top of the contact list. The contacts that do not have social network weighting are arranged in any order, such as alphabetical or numerical order. The social network weighting may be used for a primary sort (i.e., sort initially by social network weighting) or a secondary sort (e.g., sort by city with contacts in each city sorted by social network weighting).

The processor 21 may cause the contact list 25 to be displayed on the display device 24. The display device 24 may display all, some, or none of the contact list 25. For example, the display device 24 may display three contacts in the contact list, even though there may be ten (10) total contacts in the contact list 25. The input device 23 may be used to navigate or scroll through the contact list 25.

Referring back to FIG. 2, the memories 22, 42 are computer readable storage media. The computer readable storage media may include various types of volatile and non-volatile storage media, including but not limited to random access memory, read-only memory, programmable read-only memory, electrically programmable read-only memory, electrically erasable read-only memory, flash memory, magnetic tape or disk, optical media and the like. The memories 22, 42 may be a single device or a combination of devices. The memories 22, 42 may be adjacent to, part of, networked with and/or remote from the processors 21, 41.

The memories 22, 42 may be computer readable storage media having stored therein data representing instructions executable by the programmed processors 21, 41 for arranging a contact list 25. The memories 22, 42 store instructions for the processors 21, 41. The processors 21, 41 are programmed with and execute the instructions. The functions, acts, methods or tasks illustrated in the figures or described herein are performed by the programmed processors 21, 41 executing the instructions stored in the memory 22, 42. The functions, acts, methods or tasks are independent of the particular type of instructions set, storage media, processor or processing strategy and may be performed by software, hardware, integrated circuits, firm ware, micro-code and the like, operating alone or in combination. The instructions are for implementing the processes, techniques, methods, or acts described herein.

The memory 22 may store the contact list 25. The processor 21 may cause the contact list 25 to be stored in memory 22. For example, the processor 21 may read or write the contact list 25. The contact list 25 may be accessed for processing. For example, the contact list 25 may be accessed, arranged based on social network service context, and displayed on the display device 24.

The memory 22 may store data representing instructions executable by programmed processor 21. The instructions may be executed to arrange a contact list 25 as a function of social network context. The instructions may include acts shown in the Figures or described herein. For example, as shown in FIG. 2A, the instructions may include receiving instructions 26, ordering instructions 27, and displaying instructions 28.

The receiving instructions 26 may be executed to receive a social network weighting for one or more contacts in the contact list 25. The social network weighting may be received from the server 40 or memory 22.

The ordering instructions 27 may be executed to arrange the contact list 25 based on the social network weightings for one or more contacts. Arranging the contact list 25 may include comparing the social network weightings to determine the contact with the social network weighting having the greatest weight. In other words, the social network weightings may be compared to determine the contact most likely to be selected based on the social network context. The contact list 25 may be arranged in any sequence or combination of sequences. The displaying instructions 28 may be executed to display the arranged contact list on the display device 24.

The input device 23 may be dial pad, key board, touch pad, scroll device, or other input device. The input device 23 may be used to input information to the processor 21. The processor 21 may use the input information to search for a contact in the contact list 25. In the example above, Bob Johnson may begin typing Jack's name (e.g., “Ja”) using the dial pad on his cellular phone.

The display device 23 may be a CRT, monitor, flat panel, a general display, LCD, projector, printer or other now known or later developed display device for outputting determined information. The display device 23 may display one or more images. For example, the display device 23 displays a contact list 25. In another example, the display device 23 displays input information.

The display device 23 may be used to display social network information. The display device 23 may display a graphical interface that illustrates social network context generated by a social network service. In the example above, the display device 23 may display a graphical interface that includes one, some, or all of the features shown in FIG. 4. For example, the display device 23 may be used to view network 51 information, public message 52 information, event 54 information, private message 53 information, profile 55 information, or information relating to another's social network profile, messages, or other information. The social network weights may be displayed.

FIG. 8 shows a method for arranging a contact list. The method is implemented using the system 10 of FIG. 1 or a different system. The acts may be performed in the order shown or a different order. The acts may be performed automatically, manually, or the combination thereof. The acts may be performed continuously, intermittently, or as a rule. For example, act 820 may be performed at a defined period of time, when a social network interaction occurs, and/or each time a user finishes using a social network service

The method includes determining a social network weighting for one or more contacts in a contact list, and arranging the contact list as a function of the social network weighting for one or more contacts. Additional, different, or fewer acts may be provided.

In act 810, a social network weighting is determined. A social network weighting may be determined for one or more contacts in a contact list is determined. For example, a social network weighting may be determined for each individual in a contact list and social network. The social network weighting may be an overall weighting.

Determining a social network weighting may include determining a social network weighting based on social network context, transmitting a social network weighting, receiving a social network weighting, or a combination thereof. Additional, different, or fewer acts may be provided. For example, a communication device may receive social network context and determine a social network weighting based on social network context.

A social network weighting may be determined based on social network context. Social network context may include the interactions, activities, and/or associations of a social network user. The interactions, activities, and associations may be assigned a weight. The weight may be determined based on the likelihood that the contact will be selected in the contact list. The likelihood that the contact will be selected in the contact list may be based on the date, importance, or type of social network interaction, activity, or association.

The user may be able to adjust the weighting or determination of the weighting. For example, the user indicates attendance at events as being more highly weighted than other context. The relative weights for different context may be set statistically, such as being based on a study of contacts by context. The relative weights may adapt, such as determining a particular users contact usage pattern in light of social context.

The social network weighting may be transferred from a server monitoring a social network service. Monitoring a social network service may include monitoring social network context. A communication device may receive the social network weighting.

In act 820, the contact list is arranged as a function of the social network weightings for one or more contacts. Arranging the contact list may include comparing social network weightings. For example, a first social network weighting for a first contact may be compared to second social network weighting for a second contact. The contact list may be arranged so that the first or second contact with a greater weighting is arranged above the first or second contact with a lesser weighting.

One benefit of using social network context to arrange a contact list is that the arranged contact list reflects a user's interactions, activities, or associations with members of a social network. Since the user's interactions, activities, or associations may indicate an increased likelihood that the user will contact a member of the social network, the user's interactions, activities, and associations may be used to identify members of the social network that a user is likely to contact.

Various embodiments described herein can be used alone or in combination with one another. The forgoing detailed description has described only a few of the many possible implementations of the present invention. For this reason, this detailed description is intended by way of illustration, and not by way of limitation. It is only the following claims, including all equivalents that are intended to define the scope of this invention.

1. An apparatus comprising:
a memory; and
a processor in communication with the memory, the memory including computer code executable with the processor, wherein the computer code is configured to:
to determine a first social network weighting for a first contact in a social network, the social network weighting being determined based on first contact social network context,
where the first social network weighting indicates a likelihood that the first contact will be selected from a contact list.

2. The apparatus in claim 1, where the first contact social network context is a social network interaction, social network activity, or social network association.

3. The apparatus in claim 1, where the computer code is also configured to determine a first social network weighting for a first contact in a social network of a social network service.

4. The apparatus in claim 3, where the social network service is an Internet-based social network service.

5. The apparatus in claim 4, where the contact list is a cellular telephone contact list.

6. The apparatus in claim 1, where the computer code is also configured to:
determine a second social network weighting for a second contact in the contact list, where the second contact social network context is a social network interaction, social network activity, or social network association.

7. The apparatus of claim 1, where the social network context includes Internet-based social network interaction between the first contact and a contact list user associated with the contact list.

8. A method, comprising:
determining a social network weighting for one or more contacts in a contact list, where the social network weighting is determined as a function of social network context, and
arranging the contact list as a function of the social network weighting for one or more contacts.

9. The method in claim 8, where determining a social network weighting comprises receiving a social network weighting from a web server monitoring a social network service.

10. The method in claim 8, where determining a social network weighting comprises determining a social network weighting as a function of social network interaction with other social contacts.

11. The method in claim 10, where social network context comprises social network interactions, social network associations, social network activities, or any combination thereof.

12. The method in claim 10, where the social network weighting is a representation of the likelihood a contact associated with the social network weighting will be selected from the contact list.

13. The method in claim 8, comprising comparing a first social network weighting for a first contact with a second social network weighting for a second contact.

14. The method in claim 13, where arranging the contact list comprises arranging the contact list so that the first or second contact with a greater weighting is arranged above the first or second contact with a lesser weighting.

15. Logic encoded in one or more tangible media for execution and when executed operable to:
determine a first social network weighting for a first contact in a contact list and a second social network weighting for a second contact in the contact list, where the first social network weighting is based on a first contact social network context and the second social network weighting is based on a second contact social network context, and
arrange the contact list as a function of the first and second social network weightings.

16. The logic of claim 15, where social network context includes social network interaction, social network activity, or social network association

17. The logic of claim 15, where the social network weighting indicates the likelihood that a contact will be selected based on a social network interaction, social network activity, or social network association.

18. The logic of claim 15, when executed also operable to compare the first contact social network context to the second contact social network context and determine whether the first contact social network context is greater than the second contact social network context.

19. The system in claim 15, when executed also operable to arrange the contact list such that the first contact is above the second contact when the first contact social network context is greater than the second contact social network context.

20. The system in claim 15, when executed also operable to receive the first social network weighting and the second social network weighting from an Internet server that supports an Internet-based social network.
